(19) United States
(12) Patent Application Publication
(10) Pub. No.: US 2003/0188572 A1
(43) Pub. Date: Oct. 9, 2003

(54) Engine valve timing measuring method

(76) Inventors: Gary John Milson, Canton, MI (US); Carl Eugene Myerick, Sandusky, OH (US)

Correspondence Address: CARL MYERICK, 914 W. BOGART, SANDUSKY, OH, 44870, US

(21) Appl. No.: 10/406,464

(22) Filed: Apr. 3, 2003

Related U.S. Application Data
(60) Provisional application No. 60/369,907, filed on Apr. 4, 2002.

(51) Int. Cl. G01B 21/22; G01M 15/00

(52) U.S. Cl. 73/116; 73/118.1; 73/119 R

(57) ABSTRACT

A system for measuring the relationship between the top dead center of the piston and the centerline of the cam lobe in an internal combustion engine, commonly known as “Installed Cam Angle”. A rotary encoder mounted to the end of the crankshaft, and linear encoders mounted over the piston and the cam lobe lifter provide data which is calculated to provide the angle between TDC and the cam lobe centerline. The method is useful during the build of an engine, particularly high performance and racing applications.

### CROSS-REFERENCE TO RELATED APPLICATIONS

We hereby reference a provisional patent application No. 60/369,907

### STATEMENT REGARDING FEDERALLY SPONSORED RESEARCH OR DEVELOPMENT Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

Our invention pertains to the requirement of measuring the precise orientation of the camshaft to the crankshaft in a four stroke internal combustion engine.

The traditional method of accomplishing this measurement uses a degree wheel (a circular disk with 360 equally spaced markings about its perimeter) attached to the end of the crankshaft (commonly called the crank snout), a length of wire attached to the engine block and bent to project over the edge of the degree wheel, a dial indicator mounted to measure the rise and fall of the cylinder one intake lifter, and a block bolted to the engine deck face to stop the piston near the top of its travel. The crankshaft is rotated until the piston coming against the block stops the rotation. The degree marking on the degree wheel closest to the wire is noted. The crankshaft is rotated in the reverse direction until it again stops. The degree marking that is midway between the current marking and the earlier noted marking is recorded as TDC (top dead center). The stopping block is then removed. The crankshaft is rotated until the highest rise of the lifter is noted on the dial indicator and the dial is zeroed. The crankshaft is again rotated until a desired fall of the lifter is seen (usually 0.015 inch) and the degree marking on the degree is noted. The crankshaft is rotated in the reverse direction (past the highest rise) until the same desired fall of the lifter is seen. The degree marking that is midway between the current marking and the earlier noted marking is recorded as the centerline of the camshaft lobe. The mathematical difference between TDC and the centerline of the camshaft lobe is recorded as the measured installed camshaft angle. If the measured installed camshaft angle does not equal the desired or specified installed camshaft angle, the cam gear is moved and the measuring procedure of the lifter is repeated.

The quality of the results using the traditional procedure is directly dependent upon the skill and attention of the operator even more than the accuracy of the dial indicator, the resolution of the degree wheel (larger diameters provide a greater resolution due to the greater perimeter), or the diameter of the bent wire.

If the bent wire is disturbed, or the degree wheel moves relative to the crankshaft at any time during the procedure, the entire procedure must be restarted.

If the degree wheel is moved relative to the crankshaft during the moving of the cam gear, the procedure must be restarted. As a result, the measured results after an adjustment (moving) of the cam gear are rarely accepted as final and the entire procedure is repeated.

Proper dialing in of the camshaft using the traditional procedure requires a large amount of time.

### BRIEF SUMMARY OF THE INVENTION

Our invention is a method for determining angular relationship of the camshaft lobe to the piston top dead center in internal combustion. A rotary (angle) encoder monitors two rotations of the crankshaft while linear transducers (probes) take simultaneous readings of the rise of the piston and of the rise of the cam lobe lifter. The data is computer collected and scanned for the angle at which top dead center (TDC) of the piston occurred. The computer then scans the data for the angles at which the desired fall on either side of highest rise of the lifter occurred. The middle of the angles is algebraically calculated and the resultant lobe centerline is compared to the TDC and displayed as “Installed Cam Angle”. Additionally, the collected data is archived by the computer providing for further comparisons and analysis.

Our invention provides much more accurate results with closer definition than is achievable using the traditional degree wheel. The precision is dependent on the rotary encoder and linear encoders which are many times more accurate than a degree wheel and dial indicator. The data is collected without interpretation of the operator.

Our invention provides quality results independent of the skill of the operator.

Our invention provides quality results in much less time than is required to perform the traditional degree wheel method.

Our invention provides for the maintaining of records and later analysis.

Our invention requires that the crankshaft only be turned in one direction (usually the direction the engine runs) eliminating any backlash errors.

Our invention provides the ability to measure the exhaust lobe the same as measuring the intake lobe, as well as simultaneously.

Our invention makes it practical to measure multiple cylinders of the engine.

### BRIEF DESCRIPTION OF THE SEVERAL VIEWS OF THE DRAWING Not applicable

### DETAILED DESCRIPTION OF THE INVENTION

Our invention consists of a data collecting interface, a rotary encoder, and one or more linear encoders. A computer is used to calculate the installed cam angle from the collected data.

Our invention uses the rotary encoder to measure and report the rotation of the crankshaft. Adapters (designed to fit each engine model and variation) are used to attach the rotary encoder directly to the crankshaft end. A torsion arm mounted to the case of the rotary encoder is firmly fastened to the engine block. As the crankshaft rotates relative to its engine block, the rotary encoder monitors its rotary angle.

Our invention uses a linear encoder to measure the rise and fall of the piston. A bracket (designed to fit a particular engine or variation) holds the linear encoder parallel to the travel of the piston. As the piston approaches TDC, the linear encoder monitors its rise. After observing TDC, the linear encoder is then moved to be held over and parallel to the cam lobe lifter to monitor the cam lobe profile. Since this requires two additional revolutions of the crankshaft, it is practical to use a second linear encoder to monitor the cam lobe profile simultaneously to the monitoring of the piston rise. Additional linear encoders allow the simultaneous monitoring of additional cam lobes.

Our invention uses a real time data collection interface to collect the measurement data and forward it to the computer where the subsequent calculations to determine TDC, cam lobe centerline, and installed cam angle are performed.

1. We claim as our invention the method of utilizing a rotary encoder mounted on the end of the crankshaft and a linear encoder or encoders mounted over the cam lobe lifter and piston to provide simultaneous data for determining the installed cam angle of an internal combustion engine.
